(19) United States
(12) Patent Application Publication
(10) Pub. No.: US 2008/0093513 A1
(43) Pub. Date: Apr. 24, 2008

(54) BABY BOTTLE HOLDER

(76) Inventor: Vicki Kunzelman, Indianapolis, IN (US)

Correspondence Address: BAKER & DANIELS LLP, 300 NORTH MERIDIAN STREET, SUITE 2700, INDIANAPOLIS, IN, 46204, US

(21) Appl. No.: 11/952,311

(22) Filed: Dec. 7, 2007

(51) Int. Cl. A61J 9/06

(52) U.S. Cl. 248/102

(57) ABSTRACT

A method and apparatus configured to promote or encourage baby self feeding. A baby bottle holder including a body defining an area to encourage the hands or arms of the baby to access the bottle. A baby bottle holder including hypoallergenic filler.

### TECHNICAL FIELD

The invention relates to a baby bottle holder. More specifically, the invention relates to a baby bottle holder configured to promote or encourage baby self feeding.

### BACKGROUND

Human infants (interchangeably referred to as babies) should be fed on demand. Typically babies are fed by bottles, which may contain formula, milk, juice, water, or other fluids. Most babies are unable to feed themselves. More specifically, most babies are unable to hold a baby bottle in the correct position for feeding.

The position of the baby bottle is important. It is undesirable to let a baby take in too much air when feeding. To minimize the amount of air which the baby takes in, the bottle may be positioned to maintain the fluid in the nipple of the bottle as the amount of fluid in the bottle decreases. One way to position the bottle includes tilting the bottle at an appropriate angle, typically with the nipple downward in relation to the rest of the bottle.

The baby's parent or caregiver typically has to maintain the baby bottle in an appropriate position for a prolonged period of time during the infant's feeding. There are several baby bottle holders which provide the baby bottle in an inclined position for baby feeding without the need of the parent or caregiver's assistance to maintain the bottle positioning.

### SUMMARY

A baby bottle holder for use with feeding an infant including a body defining an area, a bottle fastener coupled to the bottle and the body, the bottle fastener configured to provide the nipple of the bottle to the mouth of the baby, and a support fastener coupled to the body, the area configured to encourage the hands or arms of the baby to access the bottle.

A baby bottle holder for use with feeding an infant including a body including hypoallergenic filler, a bottle fastener coupled to the body, the bottle fastener configured to couple to the bottle, the bottle fastener configured to provide the nipple of the bottle to the mouth of the baby, and a support fastener coupled to the body.

A method of baby self-feeding with a bottle, comprising the step of: providing a body defining an area configured to encourage the hands or arms of the baby to access the bottle.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of one embodiment of a baby bottle holder of the present invention.

FIG. 2 is a perspective view of the baby bottle holder as shown in FIG. 1 and in use with a baby.

FIG. 3 is a perspective view of the baby bottle holder shown in FIG. 1 in use with the baby.

FIG. 4 is a perspective view of a baby bottle holder shown in FIG. 1 in use with the baby.

Corresponding reference characters indicate corresponding parts throughout the several views. Although the drawings represent embodiments of the present invention, the drawings are not necessarily to scale and certain features may be exaggerated in order to better illustrate and explain the present invention.

### DETAILED DESCRIPTION OF THE EXEMPLARY EMBODIMENTS

The embodiments disclosed below are not intended to be exhaustive or limit the invention to the precise forms disclosed in the following detailed description. Rather, the embodiments are chosen and described so that others skilled in the art may utilize their teachings.

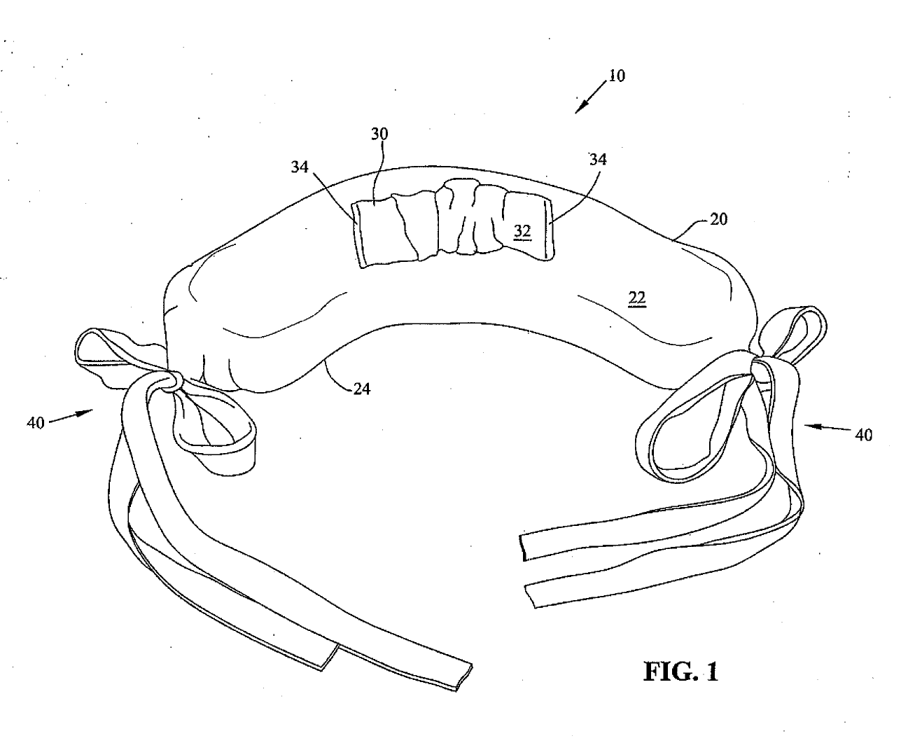

Referring to FIG. 1, a holder 10 including body 20, bottle fastener 30, and support fasteners 40 is shown. As shown in FIG. 1, body 20 is coupled to bottle fastener 30 and support fasteners 40. Body 20 supports bottle fastener 30 while support fasteners 40 are configured to support body 20.

Body 20 includes cover 22, which can be made from any material such as fabric, cotton, flannel, or fleece materials. Cover 22 may also include designs, patterns, colors, and images, to catch or attract the attention of a baby. The designs, patterns, colors and images may correspond the surroundings of the baby, including the baby's clothing, accessories or support such as a baby stroller or car seat. Furthermore, cover 22 may include textures that are safe for the baby as well as textures that attract the baby's touch. Cover 22 may also be made from materials that are easily washable and cleanable that may prevent staining and that may prevent bacterial growth, for example.

Body 20 may also include a filler (not shown), which may include a down-like fiber filler. In a separate embodiment, the filler may also include a hypoallergenic fiber filler. In one embodiment, filler is configured to create a soft surface for the baby or the baby bottle. In another embodiment, the filler retains a bottle in a position for feeding. For example, the filler may also include foam. The foam may define a cutout region adjacent to the bottle fastener 30 to allow for a bottle in a feeding position. The cutout may maintain the bottle in a tilted position to direct fluid to the nipple. The tilted position may minimize the amount of air taken in by the infant. In another embodiment, the filler may be any freely shiftable material to allow placement and retention of the bottle position.

In one embodiment, as shown in FIG. 1, body 20 has a curved shape 24, as discussed in greater detail below. Curved shape 24 may assist baby in feeding wherein the holder supports the bottle or self-feeding wherein the baby supports or substantially supports the bottle. Similar to curved shape 24, additional cutout or cutouts of the filler, ledges or other similar structural additions or modifications may provide equivalent structure.

Bottle fastener 30 may include elastic band (not shown) enclosed within cover 32. Cover 32 may be similar to cover 22 in all terms including materials, patterns, and designs for example. Bottle fastener 30 may be fastened to body 20 at fastening ends 34 by any means such as sewing, adhesion, hook and loop type fasteners such as Velcro®. Bottle fastener 30 may also include any sort of fastener system such as hook and loop fasteners, adhesives, members size to be sleeved over bottle straps and handles.

Bottle fastener 30 is configured to enable a bottle to be available for a feeding by the infant by placing the nipple adjacent to the infant's mouth. Bottle fastener 30 may be configured to allow the infant to move the bottle out of the infant's mouth. Bottle fastener 30 may be configured to not apply excessive pressure against the bottle thereby allowing the infant to remove the bottle from the infant's mouth. In another embodiment, bottle fastener 30 is configured to place the bottle on the appropriate angle for feeding a baby positioned adjacent to the holder.

Still referring to FIG. 1, support fasteners 40 are shown as adjustable straps. In other embodiments, support fasteners 40 may include any of the similar fasteners as contemplated for bottle fastener 30. Adjustable straps are configured to allow adjustment of holder 10. Adjustable straps are configured to allow for use of holder 10 in multiple positions in relation to a support in conjunction with the baby. As discussed in greater detail below, support fastener 40 is configured to mount to any support such as an infant carrier, stroller, or car seat or any structure adjacent to a resting or supporting place for an infant. Support fastener 40 is configured to support holder 10 for supporting the bottle provided for infant feeding.

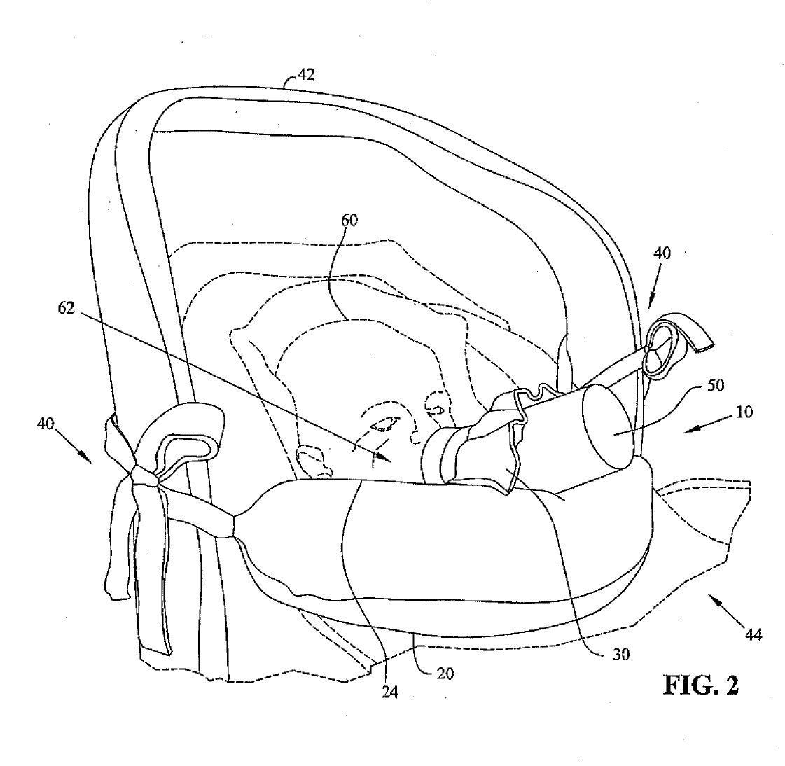

Holder 10 provides a bottle in a suitable position adjacent to the infant's mouth to enable the baby to feed. In one embodiment, holder 10 provides bottle 50 to baby 60 without the need for a parent or caregiver to hold bottle 50, as shown in FIG. 2. As shown in this embodiment, holder 10 is positioned in part by support fasteners 40 shown as adjustable straps.

As shown in FIG. 2, support fasteners 40 are fastened to support 42, shown as a handle to baby seat 44. Support fasteners 40 are shown as adjustable straps tied into a knot around support 42. Another embodiment of adjustable straps 40 are configured to be supported at any position along support 42. In one embodiment, holder 10 is configured to hang from support 42. As shown in FIG. 2, holder 10 is shown in use with baby bottle 50. Holder 10 is shown in feeding baby 60 by use of baby bottle 50. In this embodiment, curved shape 24 keeps body 20 of holder 10 away from baby's 60 facial area 62.

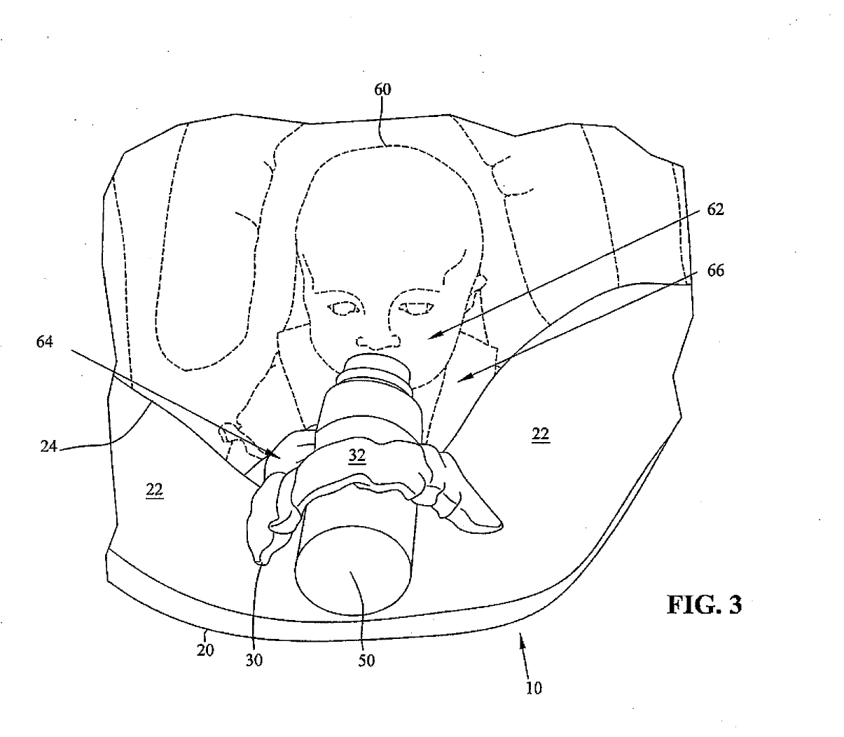

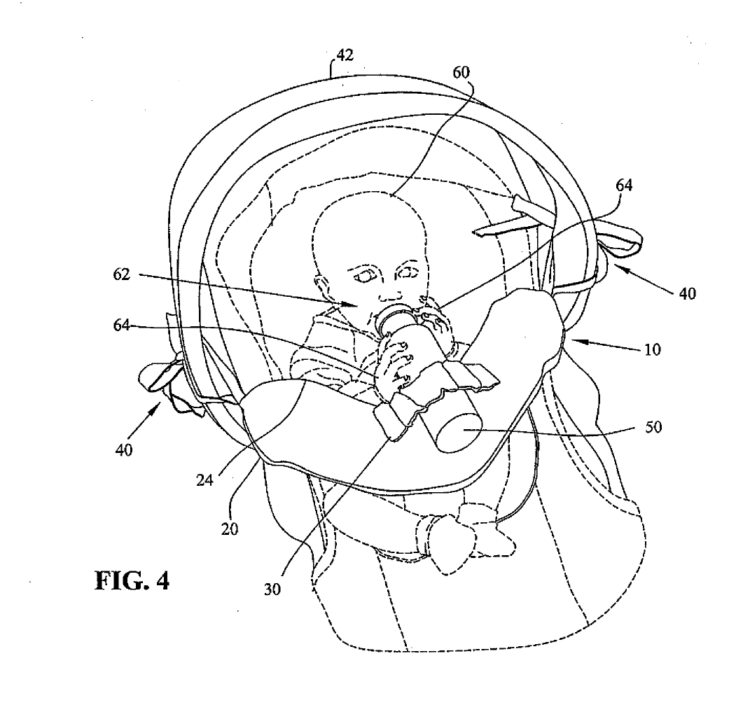

As shown in FIG. 3, in another embodiment, holder 10 is configured to encourage baby 60 to interact with holder 10 and bottle 50. In another embodiment, holder 10 is configured to encourage baby 60 to contact or grab bottle 50. As previously described, covers 22 and 32 may include textures, colors, and patterns that are appealing to baby 60. Holder 10 may be configured to operate within the range of baby's hands 64. Curved shape body 24 may create a range of motion for baby's hands 64 to interact, touch or grab holder 10 or baby bottle 50 as shown in FIG. 3. Furthermore, body 20 may restrict baby's hands 64 range of motion to area 66 between baby's facial area and curved shape 24 of body 20. As shown in FIG. 4, in another embodiment, curve shape 24 of body 20 may encourage baby 60 to grab or hold bottle 50 in an appropriate bottle position to promote infant self-feeding.

Holder 10 may include several equivalents to curved shape 24 to define area 66. As previously mentioned, additional cutout or cutouts, ledges or other similar structure or structural modifications to holder 10 may define area 66 and provide interaction, touch or grab response in baby 60. For example, additional cutouts of body 20 may provide resting places for baby's hands 64.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A baby bottle holder for use with feeding an infant, comprising
a body defining an area,
a bottle fastener coupled to the bottle and the body, the bottle fastener configured to provide the nipple of the bottle to the mouth of the baby, and
a support fastener coupled to the body,
the area configured to encourage the hands or arms of the baby to access the bottle.

2. The baby bottle holder of claim 1 wherein the body includes a curved shape, the curved shape configured to encourage the hands or arms of the baby to access the bottle.

3. The baby bottle holder of claim 2 wherein the body has a semicircular shape.

4. The baby bottle holder of claim 1 wherein the body includes filler.

5. The baby bottle holder of claim 4 wherein the filler is hypoallergenic.

6. The baby bottle holder of claim 1 wherein the body encourages the hands or arms of the baby to grab or hold the bottle.

7. The baby bottle holder of claim 6 wherein the body encourages the baby to grab or hold the bottle in an appropriate position for feeding.

8. The baby bottle holder of claim 1 wherein the body restricts motion of the arms or hands of the baby.

9. The baby bottle holder of claim 1 wherein the body limits the range of motion of the arms or hands of the baby.

10. The baby bottle holder of claim 1 wherein the support fastener is an adjustable strap.

11. The baby bottle holder of claim 2 further comprising
a plurality of support fasteners coupled to the body.

12. The baby bottle holder of claim 1 wherein the bottle fastener includes an elastic strap.

13. The baby bottle holder of claim 7 wherein the elastic strap fastens the bottle between the body and the bottle fastener.

14. The baby bottle holder of claim 1 wherein the body includes a cover, the cover including attractive elements.

15. A baby bottle holder for use with feeding an infant, comprising
a body including hypoallergenic filler,
a bottle fastener coupled to the body, the bottle fastener configured to couple to the bottle, the bottle fastener configured to provide the nipple of the bottle to the mouth of the baby, and
a support fastener coupled to the body.

16. A method of baby self-feeding with a bottle, comprising the step of:
providing a baby bottle holder including a body defining an area configured to encourage the hands or arms of the baby to access the bottle.

17. The method of claim 16 further comprising the step of
substantially restricting motion of the hands or arms of the baby to the area.

18. The method of claim 16 further comprising the step of
substantially limiting range of motion of the arms or hands of the baby to the area.

19. The method of claim 16 wherein the body defines a semicircular shape, the semicircular shape defining the area.

20. The method of claim 16 further comprising the step of
providing adjustable straps coupled to the body, the adjustable straps configured to couple the body to any support.
